(19) United States
(12) Patent Application Publication
(10) Pub. No.: US 2003/0097301 A1
(43) Pub. Date: May 22, 2003

(54) Method for exchange information based on computer network

(76) Inventors: Masahiro Kageyama, Hino (JP); Tomokazu Murakami, Tokyo (JP); Hisao Tanabe, Hachioji (JP); Toshihiro Yamada, Tokyo (JP); Akio Shibata, Higashimatsuyama (JP)

Correspondence Address: Mattingly, Stanger & Malur, P.C., Suite 370, 1800 Diagonal Road, Alexandria, VA, 22314, US

(21) Appl. No.: 10/083,359

(22) Filed: Feb. 27, 2002

(30) Foreign Application Priority Data
Nov. 21, 2001 (JP) 2001-355486

(51) Int. Cl. G06F 17/60; G06F 15/16; G06F 17/30

(52) U.S. Cl. 705/14; 709/205; 707/10

(57) ABSTRACT

Because the conventional search service with the WWW search engine assumes keyword input by end users, it is impossible for users to request a search by specifying visual information rendered by TV broadcast or from other sources as a search key or, in reverse, issue a search request for a scene of a TV program by specifying a keyword. The disclosed invention provides an information linking method, terminal devices and a server equipment operating, based on this method, a computer program of the method, and a method of charging for services feasible by the method. This method makes the following possible: linking visual information distributed by TV broadcast or over a computer network with text information such as keywords; and searching WWW sites/pages with a search key of visual information such as an visual object on a image from a TV program or, in reverse, searching for a scene of a TV program from a keyword.

### BACKGROUND OF THE INVENTION

The present invention relates to an information linking method for linking visual and text information and, more particularly, to such method in which a part or all of a video image obtained is used as a keyword-equivalent for searching for information related to the image.

A diversity of information is shared and exchanged across people over computer networks such as the Internet (hereinafter referred to as a network). For example, information existing on servers interconnected by the Internet is linked together by means called hyperlinks and a virtually huge information database system called the World Wide Web (WWW) is built. In general, Web sites/pages including a home page as a beginning file are built on the network, which are regarded as units of information accessible. On the Web pages, text, sound, and images are linked up by means of a hypertext-scripting language called HTML (Hyper Text Markup Language).

On the network, an information exchange system called “Bulletin Board System (BBS)”, an electronic bulletin board system, and the like is run. This system enables end users to exchange information, using their terminals such as personal computers (PCs) connected to the Internet in a manner that users connect to a server, and send text or other information that is registered on the server. Meanwhile, PC users interconnected by the Internet communicate text information one another, using software on their terminals for chat services that allows two or more people in remote locations to have conversations in a real-time mode, thereby exchanging information.

JP-A-236350/2001 (Reference 1) disclosed a technique that enables viewing advertisements associated with a specific keyword extracted from text information exchanged through an information exchange system, chat services, and the like.

A so-called “search engine” technique has been developed for searching WWW sites for Web pages including a keyword entered by an end user (Sato, et al. “Recent Trends of WWW Information Retrieval”, The Journal of the Institute of Electronics, Information and Communication Engineers, Vol. 82, No. 12, pp. 1237-1242, December, 1999) (Reference 2).

Misu, et al. presented “Robust Tracking Method of Occluded Moving Objects Based on Adaptive Fusion of Multiple Observations” (Proceedings of the 2001 ITE Annual Convention, The Institute of Image Information and Television Engineers, No. 5-5, pp. 63-64, August, 2001), which disclosed a technique for tracking an visual object of a person or the like extracted from visual information supplied by TV broadcasting or the like.

### SUMMARY OF THE INVENTION

If TV audience wants to request a search about a costume that an actress wears who acts the heroine of a drama program, he or she would have to access a search engine from a PC connected to the network, enter a search keyword that he or she thought suitable, and issue a search request. A problem or challenge existing in the conventional search engine that assumes keyword input by end users is that it is impossible for users to request a search by specifying visual information rendered by TV broadcast or from other sources as a search key or, in reverse, issue a search request for a scene of a TV program by specifying a keyword.

An object of the present invention is to provide an information linking method for linking visual information rendered by TV broadcast or distributed via a network and text information. Another object of the invention is to provide terminal devices and a server equipment operating, based on the above method and a computer program of the method. This method can provide a function that allows TV audience to select a part or all of a video image displayed on a TV receiver screen, thereby issuing a search request for information related to the video image. For example, if the audience selects (clicks) a costume that an actress wears in a TV program on the air with a pointing device such as a mouse, reference information related to the costume, such as its supplier name and price, will be displayed on the TV receiver screen.

To solve those problems, the present invention provides, in a first aspect, an information linking method for linking content of interest rendered by media and information related to an object from the content (hereinafter referred to as reference information), assuming that terminal devices (hereinafter referred to as terminals) and a server equipment (hereinafter referred to as a server) are connected via a computer network and information about content of interest rendered by media is communicated over the network. In the information linking method, a first terminal receives or retrieves first content of interest rendered by media and sends a set of first information to identify the first content of interest, information to define a part or all of an object from the first content (hereinafter referred to as first target area selected), and messages to the server across the computer network. The server receives the set of the first information to identify the first content, the first target area selected, and the messages, generates reference information from a part or all of the messages received, and interlinks and registers the first information to identify the first content, the first target area selected, and the first reference information into its database.

In another aspect, the invention provides an information linking method that is characterized as follows. The first terminal receives or retrieves first content of interest rendered by media and sends first information to identify the first content and first target area selected to define a part or all of an object from the first content to the server across the computer network. The server matches the received first information to identify the first content and first target area selected with second information to identify second content and second target area selected that have been registered in its database. If matching for both couples is verified, the server sends the second information to identify second content and the information related to the object from the content, the object being identified by the second target area selected, to the second terminal across the computer network. The second terminal receives and outputs the information related to the object from the content.

In yet another aspect, the invention provides a computer executable program comprising the steps of receiving the input of content of interest rendered by media; obtaining information to identify the content; obtaining target area selected to define a part or all of an object from the content; receiving the input of messages; transmitting the information to identify the content, the target area selected, and the messages across the computer network; receiving information related to an object from the content across the computer network; and displaying the content of interest on which the object is identifiable within the target area selected and the information related to the object, wherein linking of the object and the information is intelligible.

In a further aspect, the invention provides a computer executable program comprising the steps of receiving first information to identify content of interest, first target area selected, and messages transmitted from a first terminal across a computer network; generating information related to an object from the content from a part or all of the messages; interlinking and storing the first information to identify content of interest, the first target area selected, the messages, and the information related to an object from the content into a database; receiving and storing second information to identify content of interest and second target area selected, transmitted from a second terminal across the computer network, into the database; matching the first and second information to identify content of interest and the first and second target areas selected; and sending the messages and/or the information related to an object from the content to the second terminal across the computer network if matching for both couples is verified as the result of the matching.

These and other objects, features and advantages of the present invention will become more apparent in view of the following detailed description of the preferred embodiments in conjunction with accompanying drawings.

### BRIEF DESCRIPTION OF THE DRAWINGS

FIG. 1 is a conceptual drawing of one preferred embodiment of the present invention.

FIG. 2 is a process explanatory drawing of the present invention.

FIG. 3 is a process explanatory drawing of the present invention.

FIG. 4 shows an exemplary configuration of a terminal device used in the present invention.

FIG. 5 illustrates an example of displaying content on the display of terminals in the present invention.

FIG. 6 illustrates an example of displaying content on the display of another terminal in the present invention.

FIG. 7 is a process explanatory drawing of the present invention.

FIG. 8 is a process explanatory drawing of the present invention.

FIG. 9 is a process explanatory drawing of the present invention.

FIG. 10 is a process explanatory drawing of the present invention.

FIG. 11 is a process explanatory drawing of the present invention.

FIG. 12 is a process explanatory drawing of the present invention.

FIG. 13 is a conceptual drawing of another preferred embodiment of the present-invention.

### DESCRIPTION OF THE PREFERRED EMBODIMENTS

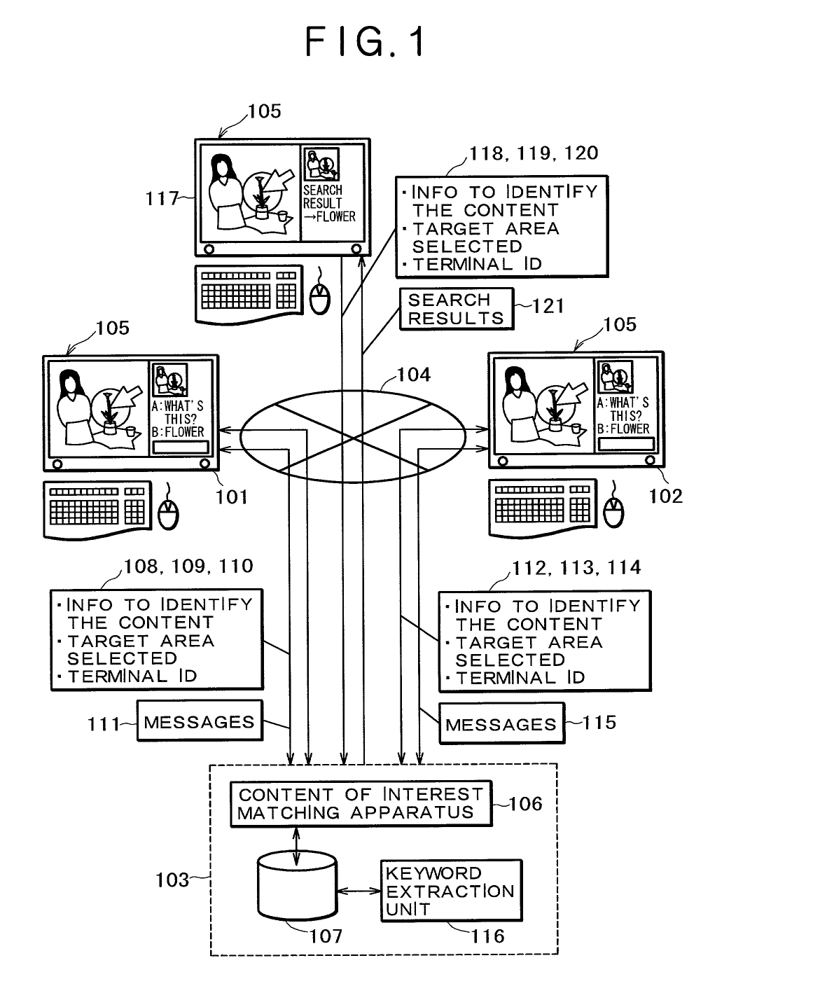

FIG. 1 is a conceptual drawing of a preferred embodiment of the present invention. This drawing represents an information exchange system in which two terminal devices for information exchange (hereinafter referred to as terminals), terminal A 101 and terminal B primarily connect to an information exchange server (hereinafter referred to as a server) 103 via a computer network (hereinafter referred to as a network) 104, wherein chat sessions between the terminals take place for exchanging information including text. Specifically, content of interest rendered by media 105 which will be explained later is input to terminal A 101 and terminal B 102 and, via the server 103, the terminals exchange information such as information to identify the content 108, 112, target area selected 109, 113, their terminal identifiers 110, 114, and messages 111, 115 including text. The server 103 comprises a content of interest matching apparatus 106, a database for information exchange 107, and a keyword extraction unit 116. The server 103 stores information received from each terminal into the database for information exchange 107 and makes up a client group of terminals by using the content of interest (keyword) matching apparatus 106 so that the terminals can communicate with each other. Methods of grouping terminals will be explained later. The server 103 analyzes messages received from each terminal by using the keyword extraction unit 116 and extracts keyword information, context information, and link information which will be explained later and stores the extracted information specifics into the database for information exchange 107.

The content of interest 105 rendered by media may be any distinguishable one for both terminals independently (that is, it is distinguishable from another content rendered by media), including a video image from a TV broadcast, packaged video content from a video title available in CD, DVD, or any other medium, streaming video content or an image from a Web site/page distributed over the Internet or the like, and a video image of a scene whose location and direction are identified by a Global Positioning System (GPS). Using an illustrative case where the content of interest is the one rendered by TV broadcasting, the present embodiment will be explained hereinafter.

At the terminal A 101, the content of interest 105 is reproduced and displayed. When the operating user of terminal A (101) takes interest in an object on the reproduced video image, the user defines the position and area of the object on the displayed image with a coordinates pointing device (such as a mouse, tablet, pen, remote controller, etc.) included in the terminal A. By way of example, as shown in FIG. 1, the user clicks on a flower in a vase displayed on the screen and defines the position and area of the flower on the display screen. At this time, the terminal A obtains the information to identify the content of interest input to it (that is, information to identify the content 108). As the information to identify the content 108, for example, the broadcast channel number over which the content was broadcasted, receiving area, etc. may be used in the case of TV broadcasting. For otherwise obtained content such as packaged video content from a video title available in CD, DVD, or the like or streaming video content, information unique to the content (for example, ID, management number, URL (Uniform Resource Locator), etc.) may be used. Terminal A 101 also obtains time information as to when the content of interest was acquired and information to identify the target position and area within the displayed image (hereinafter referred to as target area selected) from the time at which the object was clicked and the defined position and area of the object. As for the time information, the time when the content was broadcasted may be used for the content rendered by TV broadcasting. For the packaged video or streaming video content, time elapsed relative to the beginning of the title or data address corresponding to the time elapsed may be used. The time information assumed herein comprises year, month, day, hours, minutes, seconds, frame number, etc. The time may be given as a range from the time at which the acquisition of the content starts to the time of its termination measured in units of time (for example, seconds). As the target position/area within the displayed image, area shape specification (for example, circle, rectangle, etc.), parameters, and the like may be used (if the area shape is a circle, the coordinates of its central point and radius are specified; if it is a rectangle, its baricentric coordinates and vertical and horizontal edge lengths are specified). When the above time range and target area information is generated, either time range or target position/area within the displayed image may be specified rather than specifying both time range and target position/area, or the whole display image from the content may be specified. As the above-mentioned terminal identifier 110, for example, address information such as IP (Internet Protocol) address, MAC (Media Access Control) address, and e-mail address assigned to the terminal, a telephone number if the terminal is a mobile phone or the like, and user identifying information if the terminal is uniquely identifiable from the user information (name, handle name, etc.) may be used.

At the terminal B 102, on the other hand, content of interest rendered by media 105 is input and displayed, and information to identify the content 112, target area selected 113, and terminal identifier 113 are obtained through user action of defining area, as is the case for terminal A 101. The terminal B 102 obtains the information to identify the content 112, target area selected 113, and terminal identifier 114 and sends them to the server 103.

Then, the server 103 receives the information to identify the content 108, 112, target area selected 109, 113, and terminal identifier 110 114 transmitted from terminal A 101 and terminal B 102 and registers these information specifics into the database for information exchange 107, and determines whether to make up terminal A 101 and terminal B 102 into a chat client group by using the content of interest matching apparatus 106.

This determination is made in such a way as will be described below. If there is a match between both information to identify the content 108 and 112 received from terminal A and terminal B and if the target area selected 109 and the target area selected 113 overlap to some extent, the terminals A and B are grouped so that they can initiate a chat session. Specifically, assume that, watching a same program of TV broadcast, the user of terminal A 101 and the user of terminal B 102 each selected area by clicking an object on the display, wherein both areas are relatively close. Then, the server 103 determines that the same object was selected on the terminal A 101 and the terminal B 102, makes up a chat client group of these terminals, and makes the terminals interconnect, thereby initiating a chat session (through which messages 111, 115 can be exchanged between them). Then, the users of the terminals thus connected in the same chat client group can freely chat with each other. Other grouping methods are possible; for example, terminal A 101 and terminal B 102 may be registered on the server beforehand to form a chat client group. In this case, it is not necessary to check matching of the information to identify the content 108, 112 and the target area selected 109, 113. It is possible to make up a chat client group of three or more terminals so that simultaneous chats among the users of the terminals will be performed.

Then, the server 103 extracts keywords from the chat messages 111, 115 exchanged between the terminals through the chat session by using the keyword extraction unit 116 and stores the extracted keywords into the database for information exchange 107. Keyword extraction methods will be explained later.

On the server 103, the above-described process makes it possible that the object selected at the terminal A 101 (the visual flow image in the example of FIG. 1) is linked with keywords from the message 111 received from the terminal A 101 and stored into the database for information exchange 107. This is also true for terminal B 102; the object selected at the terminal B 102 is linked with keywords and stored into the database for information exchange 107.

The thus linked up visual objects and keywords are stored into an archive that can be searched by request. The search process will be described below.

At a terminal C 117 whose user is offering a search attempt, content of interest rendered by media 105 is input and displayed as described above. The operating user of terminal C 117 wants to get information related to an object on the reproduced image and defines the position and area of the object on the display. Then, the terminal sends the server 103 the information to identify the content 118, target area selected 119, and terminal identifier 120. Using the content of interest matching apparatus 106 and the database for information exchange 107, the server 103 searches the database for keywords associated with the information to identify the content 118 and target area selected 119. The server 103 sends back search results 212 via the network 104 to terminal C 117 on which the search results are then displayed. Specifically, if there is a match between the information to identify the content 118 received from terminal C 117 and the information to identify the content 108 stored in the database for information exchange 107 and if the target area selected 119 received from terminal C 117 and the target area selected 109 stored in the database 107 overlap to some extent, the server determines that both sets of information indicate the same object. Then, keywords associated with the object are retrieved as search results 121.

Although, in FIG. 1, chat client terminals A 101 and B 102 and terminal C 117 from which a search request is issued are separate for explanatory convenience, even a chat client terminal is also allowed to issue a search request. After terminal C 117 sends the server a search request, a chat session may start between terminal A 101 and terminal B 102. In view hereof, the server 103 may repeat the above-described search process periodically once having received the search request from terminal C 117. To discriminate between chat client terminal A 101/B 102 and terminal C 117 issuing a search request, arrangement is made such that chat client terminal A 101/B 102 sends the server a message exchange request and the terminal C 117 sends the server a search request.

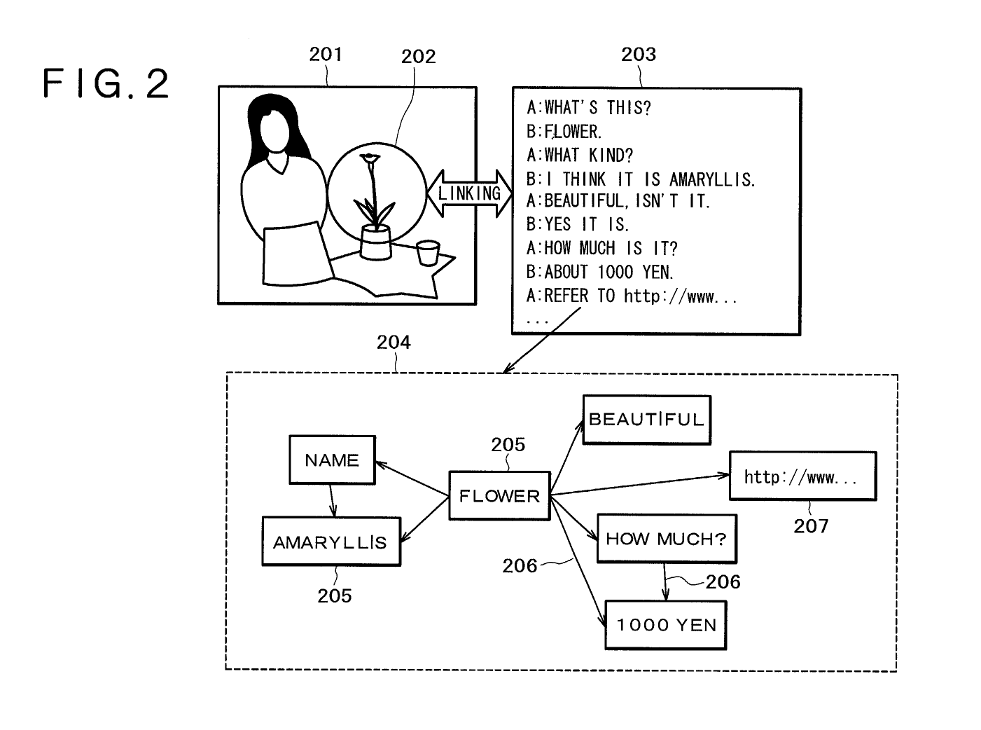

Using FIG. 2, the operation of the keyword extraction unit 116 will now be described. As described above, the area selected 202 by the user within an image displayed on the display screen 201 of terminal A 101 is linked with chat messages 203 communicated between terminal A 101 and terminal B 102; this linking is performed by the server 103. The keyword extraction unit 116 analyzes the chat messages 203 and extracts keyword information 205 including discrete words, proper nouns, etc., context information 206 indicating keyword-to-keyword connection, and link information 207 for a link with a keyword. FIG. 2 shows examples of extracted keywords: “flower,” “name,” “amaryllis,” “beautiful,” “how much,” and “1000 yen” that are keyword information 205. Then, context information 206 indicating keyword-to-keyword connection is extracted. The context information indicates the attribute of a keyword such as “name” that is a noun and “beautiful” that is an adjective and keyword-to-keyword connection such as “name” connecting with “amaryllis” and “flower” connecting with “beautiful.” Link information 207 is a character string for specific use such as a Web site address and the mail address of an end user. For extracting keywords and context information, it is possible to apply previous techniques, for example, extraction based on matching by referring to a prepared dictionary containing discrete words and word-to-word linking in meaning and the technique described in the above-mentioned reference 1. Therefore, a drawing thereof is not shown.

By analyzing the chat messages 203 in this way, the area selected 202, a part of an image selected from the content of interest 105 can be linked with keyword information 205, context information 206, and link information 207. For example, when a user selects an object shown on a specific frame of an image and is going to get keyword information about the object, terminal C 117 sends the server the information to identify the content 118 and target area selected 119 for the selected object. The server identifies the selected object from the information received, searches the database for keyword information 205 such as “flower” and “amaryllis,” and returns the search results 121 of the keywords to terminal C 117. In this way, keyword information can be obtained from visual information. In reverse, to obtain visual information from keyword information, the terminal sends the server keyword information. Then, the server identifies the selected object from the keyword information and returns the information to identify the content and target area selected to the terminal as search results. The terminal identifies the frame and scene including the object from the information received and can display the image of the selected object.

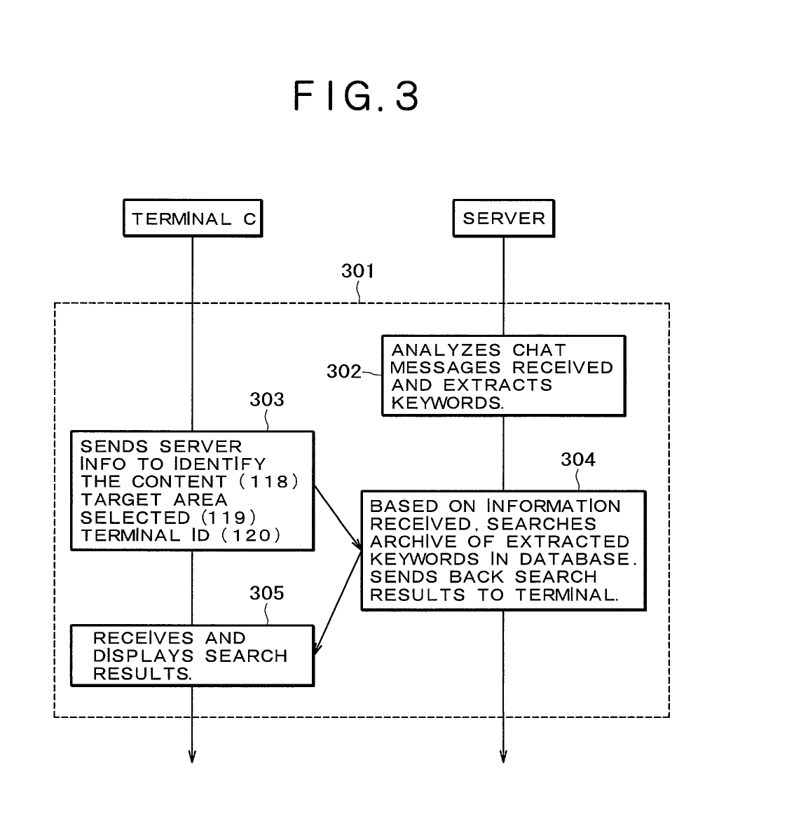

The above-described search process carried out by the server 103 in response to the search request from terminal C 117 will now be explained further, using FIG. 3, wherein this process is represented by step 301. In FIG. 3, at step 302, the server 103 first analyzes chat messages 111, 115 received and extracts keywords. The extracted keywords 204 are stored into the database for information exchange 107.

In step 303, terminal C 117 making a search attempt sends a query to the server 103. When searching for keywords from visual information, the query comprises the information to identify the content of interest 118, the target area selected 119 by which a specific object image is identified and the command to search for keywords. When searching for visual information from a keyword, the query comprises a string of characters representing the keyword and the command to search for visual information. The query also includes the terminal identifier 120 so that the server will send the terminal C 117 search results 121.

In step 304, based on the query received from terminal, the server searches the archive of the extracted keywords 204 in the database for information exchange 107 and sends search results 121 to the terminal C 117.

In step 305, the terminal C 117 receives and displays the search results 121. Upon receiving, for example, keyword information 205 as search results 121, the terminal displays a list of the keywords. Upon receiving link information 207, the terminal displays a string of characters of the link that represents a Web site address or an HTML document designated by the link. Upon receiving the information to identify the content and target area selected, the terminal extracts the appropriate frame and scene from the content of interest stored in it and displays that scene. Display may be made in combination of the above ones to be displayed. When the server 103 transmits the search results 121 to terminal C 117, the search results 121 may be in either a directly displayable form such as HTML documents or an indirect form such as an e-mail message including the search results 121.

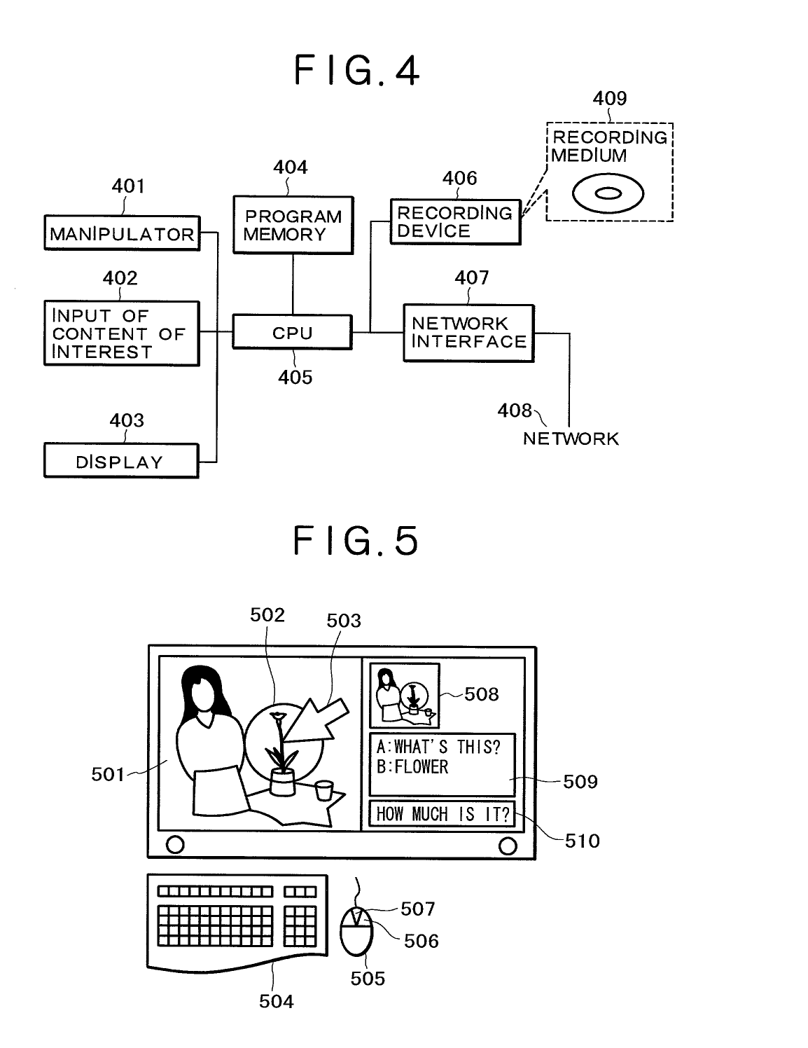

FIG. 4 shows the configuration of a terminal used in the present invention. Based on the instructions of a software program comprising the above-described steps, stored in a program memory 404, CPU 405 controls the overall operation of the terminal device. Content of interest rendered by media 105 supplied through the input of content of interest 402 is encoded so that it can be handled as digital data under the CPU. As the input of content of interest, a general TV tuner, a TV tuner board for personal computers, etc. may be used. For this encoding, methods in compliance with the ISO/IEC standards, such as Moving Picture Experts Group (MPEG) and Joint Photographic Experts Group (JPEG), and other commonly known methods are applicable, and thus a drawing thereof is not shown. During encoding, not only video signals, but also audio signals may be encoded in the same way. If previously encoded audio and video signals are input through the input of content of interest, it is not necessary for the CPU to encode the signals. Encoded signals are decoded by the CPU so that content is reproduced and presented on the display 403. Separately from the CPU, an encoder and a decoder may be provided. Output to be made on the display 403 is not only the output of content reproduced by decoding encoded video/audio signals, but also the output of HTML documents or the like for displaying character strings and symbols of chat messages 111, 115, thumbnail images, reference information, and search results 121. In view hereof, the display may be configured with a first display for outputting content reproduced from decoded video/audio signals and a second display for outputting HTML documents or the like. As the first display, a TV receiver's screen may be used; as the second display, the display of a mobile terminal (such as a mobile telephone) may be used. The encoded signals may be once recorded by a recording device 406 so that content is time-shift reproduced after a certain time interval. As a recording medium 409 on which the recording device records the signals, a disc-form medium such as a compact disc (CD), digital versatile disc (DVD), magneto-optical (MO) disc, floppy disc (FD), and hard disc (HD) may be used. In addition, a tape-form medium such as videocassette tape and a solid-state memory such as RAM (Random Access Memory) and a flash memory may be used. For time shifting, commonly known time-shifting methods are applicable, and therefore, a drawing thereof is not shown. As for the input of content of interest and the display, the corresponding functions of other devices can be used instead of them (that is, they can be provided as attachments); they may be excluded from the configuration of the terminal. The input of content of interest 402 may operate such that it simply allows the terminal to obtain information to identify the content 108, 112 and target area selected 109, 113, but does not supply the content itself rendered by media 105 to the CPU 405.

A manipulator 401 allows the user to define the target position (horizontal and vertical positions in pixels) and the target area (within a radius from the target position) on the display 403 on which an image in which the user takes interest is shown, based on the data from the above-mentioned pointing device. The manipulator 401 also allows the user to enter chat messages (using the keyboard or by selecting a desired one from a list presented) and a query for search request.

Following the instructions of the program stored in the program memory 404, the CPU 405 derives the information to identify the content of interest rendered by media 105 (channel over which and time when the content was broadcasted, receiving area, etc.) from the content supplied from the input of content of interest 402 and keeps it in storage. If time shifting is applied, the CPU makes the above information recorded with the content when the recording device records the video/audio signals of the content. The CPU reads the above information when the content is reproduced. Based on the information supplied from the input of content of interest 402, manipulator 401, and network interface 407, the CPU generates information to identify the content, target area selected, address information, messages, queries, etc. and makes the network interface 407 transmit the generated information via the network 408 to the server 103. The network interface 407 only provides the functions of transmitting and receiving commands and data over the network. Because the network interface can be embodied by using a network interface board or the like for general PCs, a drawing thereof is not shown. These functions can be implemented under the control of software installed on a PC or the like provided with a TV tuner function. In another mode of implementation, it is possible to configure a TV receiver or the like to have these functions.

It is preferable that the terminal has a thumbnail image generating function. The thumbnail image generating function gets the input of content of interest received or retrieved from the recording medium, information to identify the content, and target area selected, extracts a frame of content coincident with the time information, superposes the selected area on the frame in a user-intelligible display manner, outputs a thumbnail of the image of the frame. The information to identify the content and target area selected may be those received over the network or those obtained at the local terminal. Providing each terminal with this thumbnail image generating function makes it possible that the terminals in remote locations share a same thumbnail image by transmitting the information to identify the content and target area selected therebetween; the thumbnail image itself is not transmitted via the network.

FIG. 5 illustrates an example of displaying content on the display of terminal A 101 and terminal B 102 used in the present invention. In this example, when user A who is operating the terminal A 101 and user B who is operating the terminal B 102 are in a chat session as they watch a same TV program, visual content and chat messages displayed on each terminal are illustrated. On the display screen 501, content of interest rendered by (TV broadcast) is displayed. Now, user A operating the terminal selects area 502 of an object in which the user takes interest by defining the area, using a pointer 503. User A controls the position of the pointer 503, using a mouse 505. Using the mouse wheel 507, the user can enlarge and reduce the circle of area selected 502 and fixes the area selected by actuating the mouse button 506. When selecting area, the user may define a circle as shown or any other shape such as a rectangle. When the area selected has been fixed by the user, a thumbnail image 508 is displayed as small representation of the image from the content of interest on which the object area has been selected and fixed. A thumbnail image may be generated on the local terminal or generated on another terminal, transmitted over the network to the local terminal, and then displayed. Alternatively, a thumbnail image may be generated from the information to identify the content, the target area selected, and the content of interest rendered by media stored in the recording device/medium of the local terminal as described above. The user enters text or the like, using the keyboard 504, and chats with another terminal's user through a chat session. Entered text or the like is displayed the message input area 510. Along with directly entering characters by the keyboard, it is also possible to select characters one by one from a list of characters and symbols prepared beforehand or select a sentence from a list of sentences prepared beforehand. Contents of chat messages from a chat user at another terminal are displayed in the display area for chat 509. Accompanying information such as user name, mail address, and time when the chat message was issued may be displayed together. Accompanying information may be transmitted once in the first chat message and stored into the terminal received it or the server, then displayed, or may be transmitted and displayed each time of chat message input. A thumbnail image may be displayed for each chat message shown in the display area for chat. If a great number of chat messages are to be shown in the display area for chat, a scrolling mechanism may be used to scroll display pages.

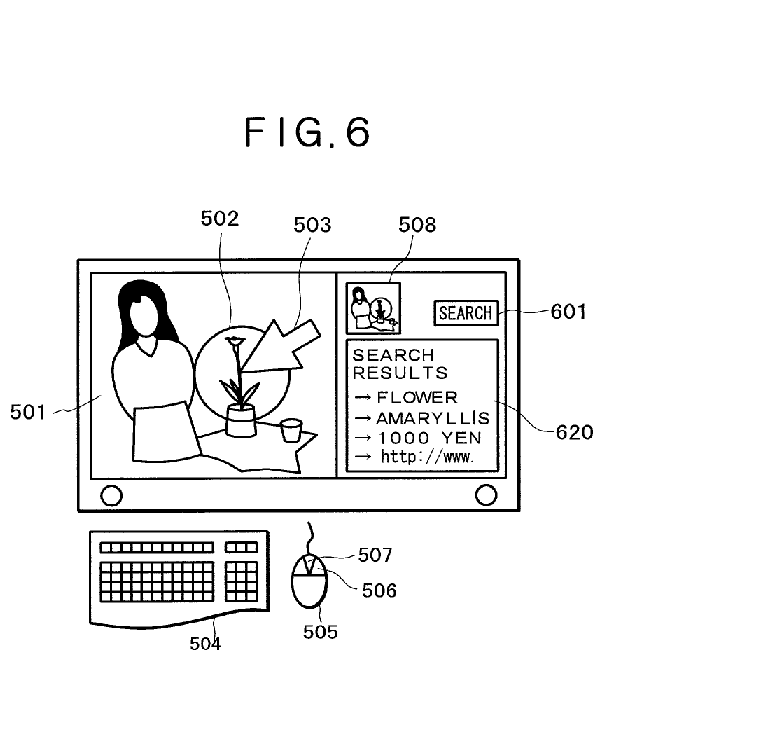

FIG. 6 illustrates an example of displaying content on the display of terminal C 117 used in the present invention. In this example, content of interest rendered by TV broadcast is displayed on the display screen 501; on the display image, user C who is operating the terminal C 117 selects area 502 of an object in which the user takes interest by defining the area, using the pointer 503, and then obtains information related to the object as search results. As is the case for FIG. 5, user C controls the position of the pointer 503, using the mouse 505. Using the mouse wheel 507, the user can enlarge and reduce the circle of area selected 502 and fixes the area selected by actuating the mouse button 506. When the area selected has been fixed by the user, a thumbnail image 508 is displayed as small representation of the image from the content of interest on which the object area has been selected and fixed. When user C presses the search button 601, the terminal sends the server 103 the information to identify the content 118 and target area selected 119 as a query. The terminal awaits search results 121 to be returned from the server. Upon receiving the search results 121, the terminal displays them in the display area for search results 602. The terminal may receive the search results 121 later by e-mail or the like as described above. In this case, the server 103 transmits the information to identify the content 118 and target area selected 119 with the search results 121 to the terminal C 117. On the terminal C 117, the associated thumbnail image 508 is reproduced and displayed, linked with the search results 121, which may help user C recall what the user looked for by search request.

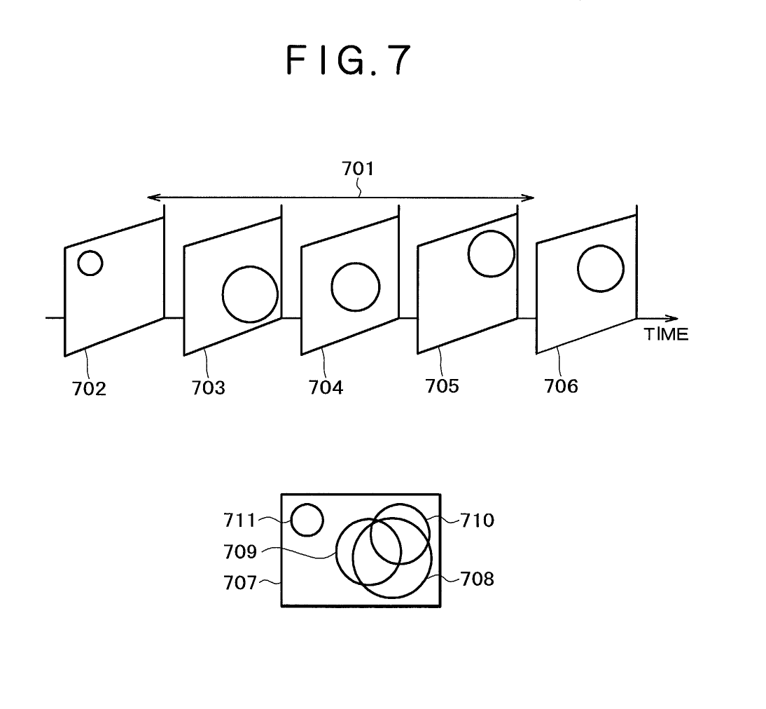

Using FIG. 7, the operation of chat client terminals A 101 and B 102 and the operation of terminal C 117 issuing a search request will now be explained. Assume that there are five terminals A, B, C, D, and E to which the same content of interest rendered by media is input. Specifically, it is assumed that the users of these terminals were watching the same TV broadcast program broadcasted over the same channel in the same area. Suppose that the users of terminals A, B, C, D, and E clicked target area on an image displayed on the terminals at different times, as represented by frames 703, 704, 705, 706, and 702 shown in FIG. 7. A certain time range 701 is set beforehand. Terminals on which clicking target area occurs within the time range are picked up as those that may be grouped. Because the frame of terminal D falls outside the time range, terminal D is set apart. A scene change frame from the content of interest is detected by the server or terminals. Even for the frames that fall within the time range 701, some of the frames before the scene change frame and other frames after the scene change are judged to be placed in different groups and may be set apart. Then, the remaining frames are put together 707 on a common plane viewed in the time direction to judge positional matching of each area selected on each frame. The areas 708, 709, and 710 respectively selected on the frames of terminals A, B, and C overlap. However, the area 711 selected on the frame of terminal E does not overlap with any other area, and therefore terminal E is set apart. In this example, terminals A, B, and C are judged to be grouped and terminals D and E are set apart. The degree of area overlap by which matching is judged is not definite. Terminals may be judged to be grouped if selected areas on their frames overlap at least in part or only if the proportion of the overlap to non-overlapped portions is greater than a certain value. Not only one frame is always captured on each terminal and not only one area is always selected on one frame. On each terminal, a plurality of frames may be captured and a plurality of areas may be selected at a time. The server makes up a group of terminals for which matching as to the information to identify the content received therefrom occurs and the overlap of the target areas selected to a certain extent is detected in the manner described above. Thereby, the users of the terminals can chat about the same object displayed on the terminals and issue a search request for information related to the object. As described above, the server 103 may make up a group of terminals on which the same object was selected (that is, a group of terminals A, B, and C) and have management of the group or make up a chat client group (that is a group of terminals A and B) and a group of terminals that are concerned in a search request (that is, a group of terminals C and A and a group of terminals C and B) and manage these groups as separate ones.

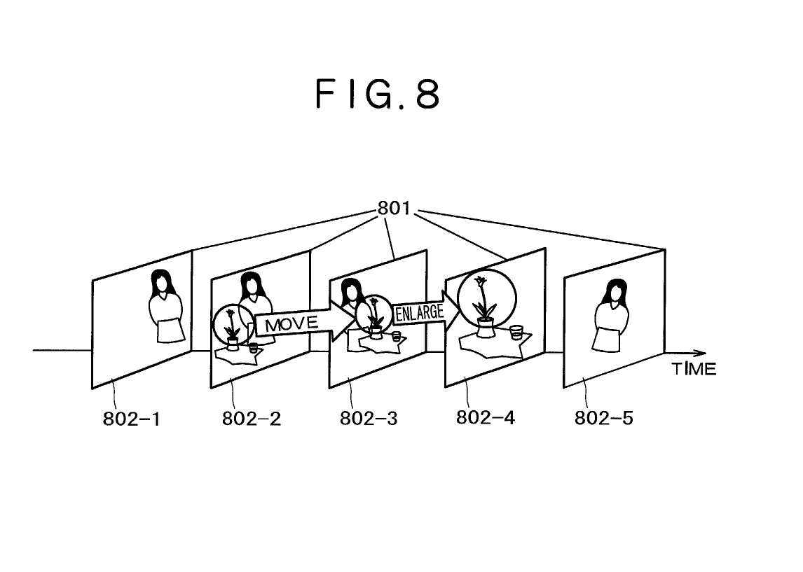

FIG. 8 depicts an object tracking process in which object images shown during a plurality of frames 802 (802-1 to 802-5 for explanatory convenience) are regarded as one object. On motion video, generally, an object at which you look moves, becomes larger or smaller, or rotates during a sequence of frames. If, for example, the area of “flower” shown on frame 802-2 was selected at terminal A and the area of “flower” shown on frame 802-3 was selected at terminal B, there is a possibility that these objects are judged discrete by the grouping method illustrated in FIG. 7. To avoid this, a technique such as the one described in the above-mentioned reference 3 is used for extracting a visual object such as the image of a person or a thing from visual information and tracking the object. By executing this object tracking, the flower images shown on frames 802-2, 802-3, and 802-4 can be recognized as one object. Consequently, the server can make up a group of terminal A at which the “flower” image on frame 802-2 was selected and terminal B at which the “flower” image on frame 802-3 was selected and have management of the group. In one possible manner, visual object tracking is performed on each terminal and its result is sent to the server, together with the information to identify the content and target area selected. In another possible manner, a plurality of contents of interest rendered by media 105 (that is, contents TV broadcasted over all channels) are input to the server and visual object tracking is performed for all contents.

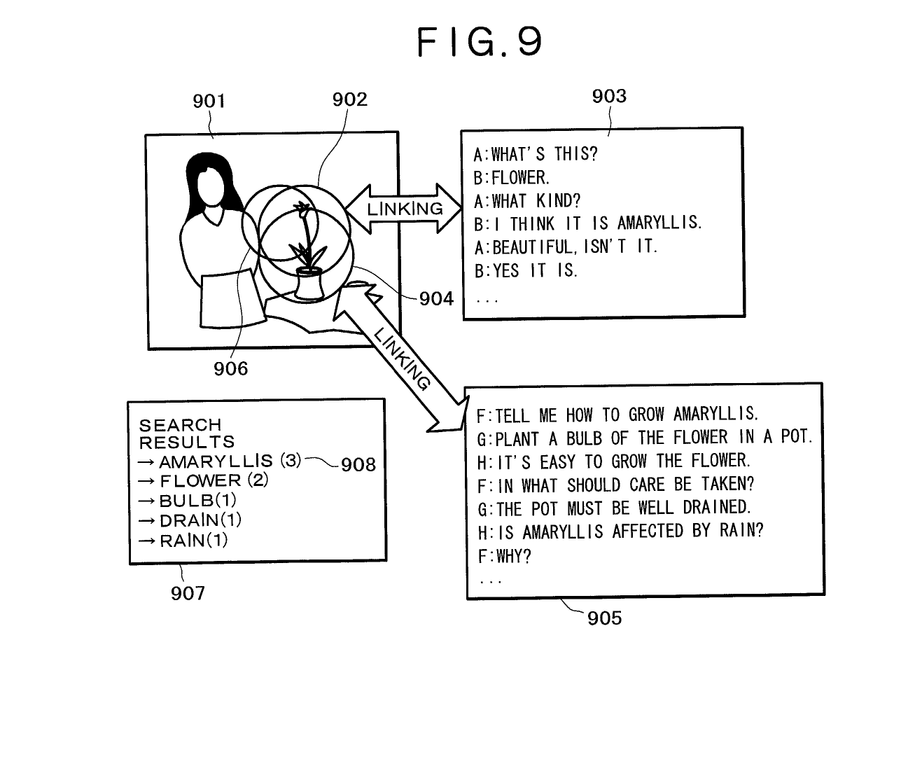

Using FIG. 9, an example of search operation when a plurality of chat sessions goes on about one object will be explained. In FIG. 9, on an image shown on the display screen 901 of terminal C, now, the user has selected an object (the area of the flower shown) and issued a search request for information about the object. At this time, it may happen that a plurality of chat sessions goes on about the object, for example, chat between terminals A and B forming one group and chat among terminals F, G, and H forming another group. In other words, the area selected 906 at terminal C, the area selected 902 at terminals A and B, and the area selected 904 at terminals F, G, and H overlap, though not completely. In that event, it is preferable that the server extracts keywords from both chat messages 903 communicated between terminals A and B and chat messages 905 communicated among terminals F, G, and H and sends back the keywords as search results 907 to terminal C. It is preferable to order the thus obtained keywords by importance level 908 which will be explained later; that is, the server or the terminal rearranges the keywords as the search results 907 so that a keyword of the highest importance level will be shown at the top and other keywords shown in place according to the importance level.

The simplest index, as the importance level 908 of a keyword is the count of appearance of the keyword within the chat messages 903 and 905. For example, keyword “amaryllis” appears three times within the chat messages exemplified in FIG. 9. Because the count of appearance of this keyword is more than that of other keywords, “amaryllis” is shown at the top.

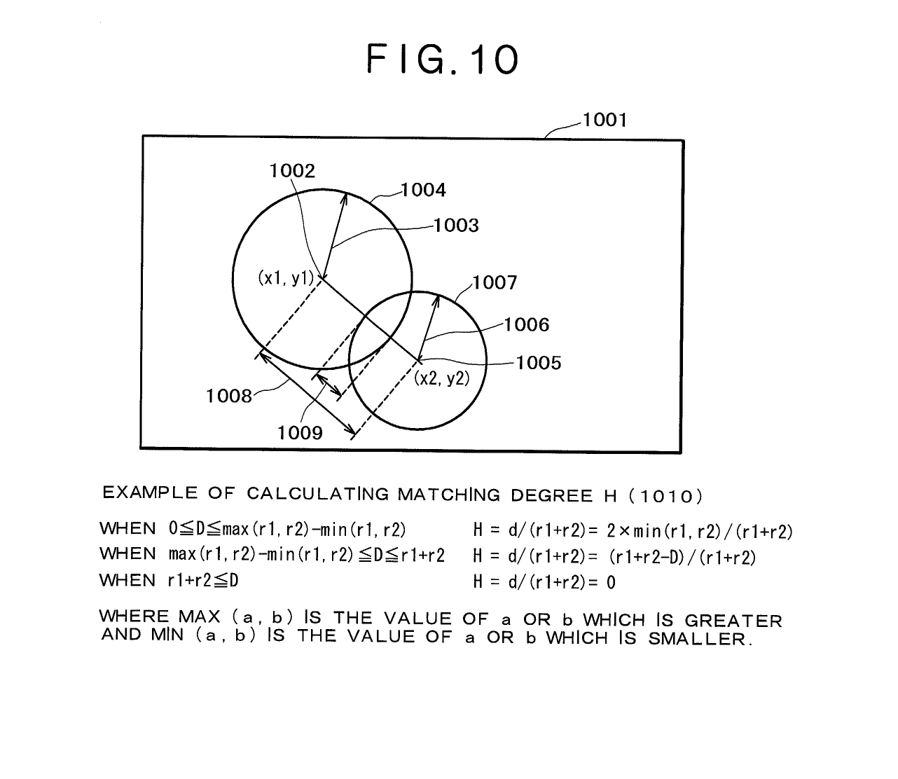

It is also possible to calculate matching degree H 1010 between the areas selected as is illustrated in FIG. 10 and weight the above count of appearance of a keyword with this degree. On a frame 1001 shown in FIG. 10, for example, area 1 selected at terminal A 1004 is a circle defined by position 1 (x1, y1) selected 1002 and radius 1, r1 (1003) and area 2 selected at terminal C 1007 is a circle defined by position 2 (x2, y2) selected 1005 and radius 2, r2 (1006). Matching degree H 1010 between both areas selected 1004, 1007 can be calculated, using diameter d 1009 or area (in units of pixels) of the overlap of two circles, and used as an index. One manner of this calculation using the diameter d 1009 of the overlap of two circles will be illustrated below. It is defined that max (a, b) indicates the value of a or b which is greater and min (a, b) indicates the value of a or b which is smaller. When one circle includes the other circle (that is, when the center-to-center distance D 1008 of the circles fulfills constraint 0≦D≦max (r1, r2)·min (r1, r2)), the diameter of the overlap is such that d=2×min (r1, r2) (that is, d is equal to the diameter of the smaller circle) . When two circles partially overlap (that is, when D fulfills constraint, max (r1, r2)·min (r1, r2)≦D≦(r1+r2)), the diameter of the overlap is such that d=(r1+r2·D). When two circles do not overlap (that is, when (r1+r2)≦D), d=0. Furthermore, as matching degree H 1010 is defined as H=d/(r1+r2), H can be normalized in the range 0≦H≦1. Matching degree H 1010 that is thus calculated is determined for positional relation between the area selected at terminal C shown in FIG. 9 and the area selected at terminal A, B, F, G, or H existing on each frame. The count of appearance of a keyword included in the chat messages is multiplied by the matching degree, thus weighted with the matching degree. Thereby, the reliability of the importance level 908 (that is, the index indicating the degree of appropriateness of a specific keyword for the object for which a search request was issued) can be enhanced.

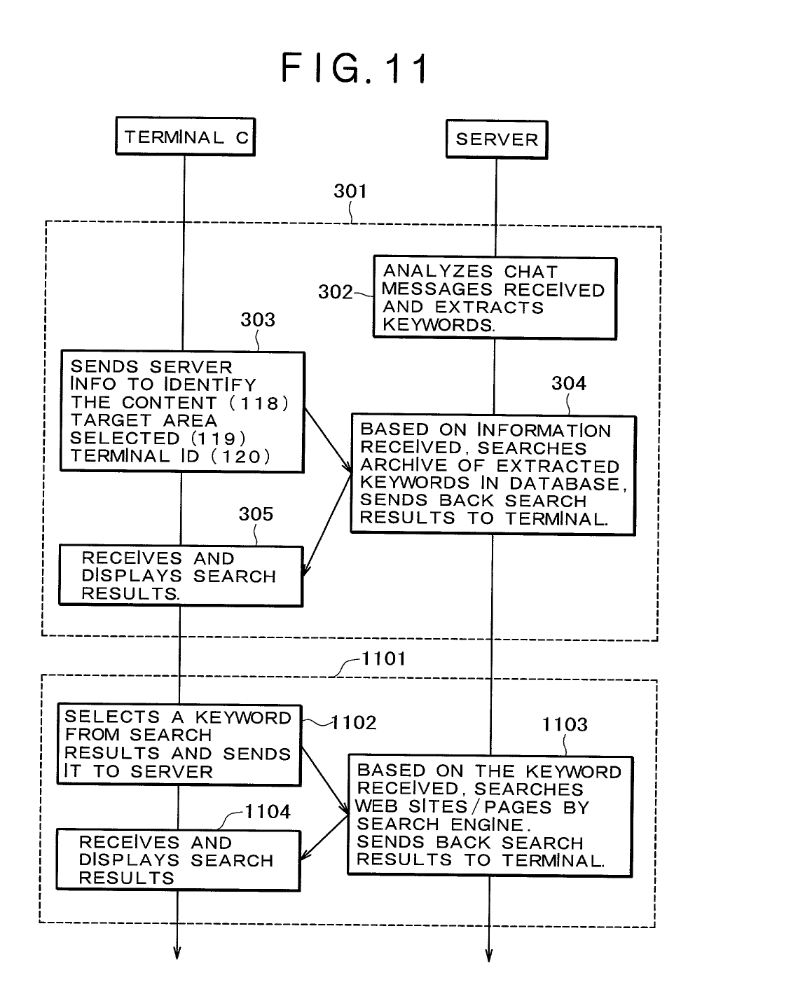

Using FIG. 11, an extended process of the step 301 shown in FIG. 3, that is, extension of the above-described search process will now be explained, wherein further information search results are obtained from keywords obtained by the above-described search method. In the above-described step 301, terminal C 117 sends the information to identify the content 118 and target area selected 119 to the server 103 (step 303), the server extracts keywords from chat messages communicated between other terminals (step 302) and sends back the keywords as search results 212 to terminal C 117 (step 304), and the search results are displayed on terminal C. In FIG. 11, a further step 1101 is added. In step 1102, from the keywords as the search results 121 shown on the display of the terminal C 117, the user selects a keyword, and the terminal C sends the keyword to the server. In step 1103, based on the keyword received, the server searches Web sites/pages by search engine and sends back a list of Web pages including the keyword to terminal C 117 as search results. In step 1104, terminal C 117 receives and displays the search results. As the search engine used in the step 1103, the technique described in the above-described reference 2 can be used.

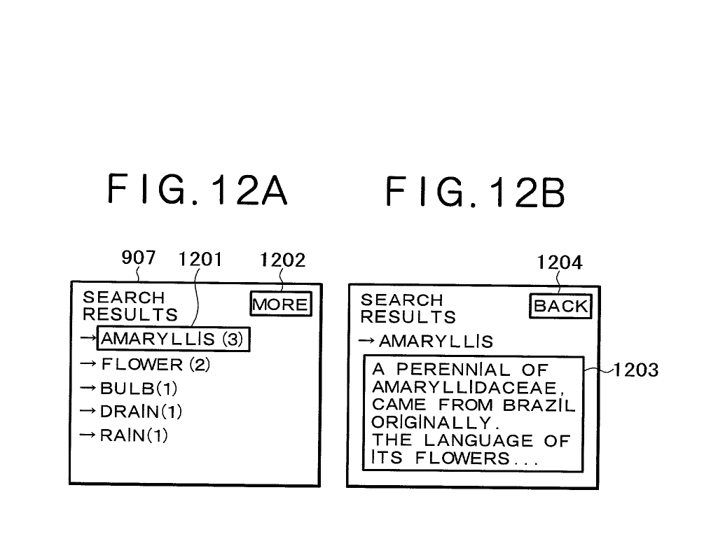

FIG. 12 illustrates examples of search results displayed before the above further search (a) and those displayed after the further search (b). In FIG. 12(a), the user of terminal C selects a keyword (“amaryllis” as an example in FIG. 12) from the search results 907 exemplified in FIG. 9, using the cursor for selection 1201. After selecting a keyword, when the user presses the further search button 1202, the step 1101 in FIG. 11 is carried out. On the terminal C, results of search by search engine 1203 can be obtained as shown in FIG. 12(b). The revert button 1204 or the like may be added so that, thereafter, the user can return the display contents to the search results displayed before the further search (a), using that button.

By using content of interest rendered by media, chat messages, and the conventional search engine in combination as described above, further information search results can be obtained by selecting a keyword about the content of interest.

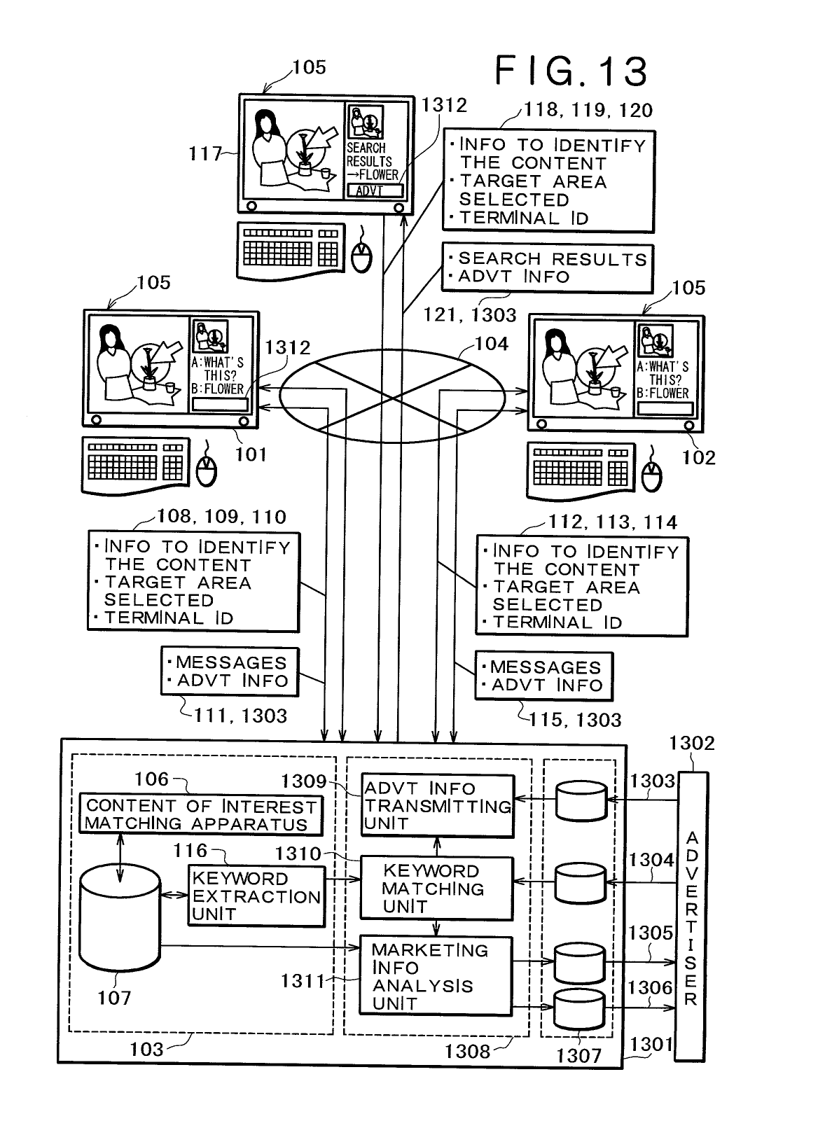

FIG. 13 is a conceptual drawing of another preferred embodiment of the invention in which advertising using the above-described information linking method is realized. Generally speaking, advertising with information concerning an object in which end users take interest is more effective than advertising for an unspecified number of general people. In view hereof, a server 1301 in this embodiment links an object (for example, a flower) selected by users with advertising information related to the object in the way described above (for example, the advertising information including the name of a flower shop, the telephone number of the shop, a map around the shop, the name of the article of trade, price, etc.). On each terminal, the advertising information is displayed near the display area for chat 509, the display area for search results 602, or the area selected 502. In FIG. 13, the server 1301 comprises an advertising generating unit 1308 and a database for advertising (1307) as well as the above-described server 103 equipment. The server 1301 receives advertising information 1303 and advertising keywords 1304 from an advertiser 1302 and returns marketing information 1305 and billing information 1306 to the advertiser 1302. Specifically, the advertiser 1302 first specifies one or more keywords (advertising keywords 1304) concerning what the advertiser wants to advertise. The keywords received by the server 1301 is stored into the database for advertising 1307 and input to the keyword matching unit 1301 from the database. For example, in the case of advertising about a flower shop, the advertising keywords 1304 are “flower,” “amaryllis,” etc. Other possible advertising keywords 1304 include nouns including the name of an article of trade, the name of one of various types of utensils, the name of a person, the name of an institution, and the name of a district such as a city; proper nouns; verbs that express an act, occurrence, or mode of being; adjectives; pronouns; and combinations thereof, i.e., compounds, phrases, and sentences. Using the above-described keyword extraction unit 116, the keyword matching unit 1310 extracts keyword information 205 from chat messages 111, 115 communicated through chat sessions. When the keyword matching unit determines that a keyword out of the extracted keyword information is linked with any advertising keyword 1304, it posts the keyword to the advertising information transmitting unit 1309 and the marketing information analysis unit 1311. It is preferable that the keyword matching unit judges a keyword out of keyword information 205 and an advertising keyword 1304 linked if a match occurs between the former keyword and the latter keyword or if it is determined that most of people would associate the former keyword with the latter keyword, based on a dictionary containing word-to-word connections in meaning (for example, connection between keyword information 205 “amaryllis” and advertising keyword 1304 “flower”). When advertising information 1303 specified by the advertiser 1302 is received by the server, it is stored into the database for advertising 1307 from which the advertising information transmitting unit 1309 receives this information and transmits it to terminals A 101, B 102, and C 117 via the network 104. This process makes it possible to transmit advertising information 1303 to not only terminal A 101 and terminal B 102 between which chat messages 111, 115 including advertising keywords 1304 specified by the advertiser 1302 are directly communicated, but also another terminal C on which the same visual object was selected as selected at the above terminals. According to the keyword posted from the keyword matching unit 1310, the marketing information analysis unit 1311 reads one or a plurality of the identifiers 110, 114, 120 of the terminals at which the object linked with the keyword was selected from the database for information exchange 107. The thus obtained terminal identifier or identifiers, together with advertising including the keyword retrieved from the database for advertising 1307, are presented to the advertiser 1302 as marketing information 1305. At the same time, charges for advertising service determined, according to the data quantity, the number of advertising keywords 1304 of the advertising information 1303 registered on the server, the number of times the advertising information 1303 has been distributed to and displayed at terminals, and the number of terminals at which the advertising information 1303 has been displayed are presented to the advertiser 1302 as billing information 1306. The above-mentioned advertising generating unit 1308 can easily be embodied by using the technique described in the above-mentioned reference 1, and therefore an explanatory drawing thereof is not shown.

It is also possible to add the information to identify the content 108, 112, 118 and target area selected 109, 113, 119 received from each terminal to the above marketing information 1305. This enables the advertiser 1302 to collect information regarding what part of an image in which the end users took interest and initiated a chat session or issued a search request and use such information in developing advertising that is more effective. Using the marketing information, a service of listing and presenting information to identify the content and target area selected per terminal identifier may also be offered at some charge.

The above-described embodiments discussed illustrative cases where the content of interest is rendered by general TV broadcasting using transmission media such as terrestrial broadcasting, broadcasting satellites, communications satellites, and cables. The present invention is not limited to these embodiments. In this invention, information (data) that is rendered in various modes is applicable, including motion and still video contents which are distributed over networks such as the Internet, motion and still video data for which where the content of interest is stored is made definite by the As information to identity the content, for example, the address of a general Web site/page on the Internet, and so on. With regard to the information for area selected with a time range for a sequence of frames, which is communicated between the terminals and the server, if only the time range is used without the target area selected within the frames, content of interest rendered by media can be audio information not including video. The present invention can also be applied to audio information distributed by radio broadcasting and over a network in the same way.

As the computer network used, an intranet (organization's internal network), extranet (network across organizations), leased communication lines, stationary telephone lines, cellular and mobile communication lines may be used, besides the Internet. As content of interest rendered by media, content recorded on recording medium such as CD and DVD can be used. While, in the above-described illustrative cases, HTML documents are used to display character strings and symbols of chat messages, thumbnail images, and reference information, other types of documents are applicable in the present invention; for example, compact-HTML (C-HTML) documents used for mobile telephone terminals and text documents if the information to be displayed contains character strings only.

The present invention makes it possible to search WWW sites/pages with a search key of visual information distributed by TV broadcasting or over a network or search for a scene of a TV program from a keyword. According to the present invention, a method and system can be provided to realize the following. When watching a TV program, only by selecting a part or all of an image displayed on the TV receiver screen without entering a search key consisting of characters, other source information related to the image will be retrieved from the server database and presented to the viewer. The invention is beneficial in that it can realize a search service business providing end users with other source information search from visual information and an advertising service business providing advertisers with advertising linked with visual objects.

While the present invention has been described above in conjunction with the preferred embodiments, one of ordinary skill in the art would be enabled by this disclosure to make various modifications to this embodiment and still be within the scope and spirit of the invention as defined in the appended claims.

What is claimed is:

1. An information linking method in which:
a first terminal device receives or retrieves first content of interest rendered by media and sends first information to identify said first content, first target area selected to define a part or all of an object from said first content, and messages to a server equipment across a computer network; and
the server equipment receives said first information to identify said first content, said first target area selected, and said messages, generates information related to the object from the content from a part or all of said messages received, and interlinks and registers said first information to identify said first content, said first target area selected, and the information related to the object from the content into a database.

2. An information linking method as recited in claim 1 wherein:
said server makes up a group of two or more terminal devices including said first terminal device and a second terminal device and sends said messages received to one or more terminal devices including said second terminal device, belonging to said group, across the computer network; and
said second terminal device receives and outputs said messages.

3. An information linking method as recited in claim 1 wherein:
said server registers advertising keywords and advertising information specified or requested by an advertiser into the database, determines whether said advertising keywords are linked with said information related to the object from the content, and sends said advertising information to terminal devices across the computer network when it has been determined that at least one of said advertising keywords is linked with said information related to the object from the content; and
the terminal devices receive and output the advertising information.

4. A terminal device comprising means for inputting content of interest rendered by media; means for obtaining information to identify the content; means for obtaining target area selected; means for inputting messages; means for transmitting said information to identify the content, said target area selected, and the messages across a computer network; means for receiving and outputting information related to an object from the content across the computer network; and means for displaying said content of interest on which the object is identifiable within said target area selected and the information related to the object, wherein linking of the object and the information is intelligible.

5. A server equipment comprising means for receiving first information to identify content of interest, first target area selected, and messages transmitted from a first terminal device across a computer network; means for generating information related to an object from the content from a part or all of the messages; means for interlinking and storing said first information to identify content of interest, said first target area selected, said messages, and said information related to an object from the content into a database; means for receiving and storing a set of second information to identify content of interest and second target area selected, transmitted from a second terminal device across the computer network, into the database; matching means for matching said first and second information to identify content of interest and said first and second target areas selected; and means for sending said messages and/or said information related to an object from the content to said second terminal device across the computer network if matching for both couples is verified as the result of the matching.

6. A server equipment as recited in claim 5 further comprising means for registering advertising keywords and advertising information specified or requested by an advertiser into a database; means for determining whether said advertising keywords are linked with said information related to an object from the content; and means for sending said advertising information to said first or second terminal device across the computer network when it has been determined that at least one of said advertising keywords is linked with said information related to an object from the content.

7. A server equipment as recited in claim 6 further comprising marketing information analysis means for generating marketing information, based on statistics obtained from any of said first information to identify content of interest, said first target area selected, said messages, said information related to an object from the content, said second information to identify content of interest, said second target area selected, and said advertising keywords, or any combination of a plurality of items thereof.

8. A server equipment as recited in claim 7, wherein
said advertising keywords include nouns including, at least, the name of an article of trade, and the name of one of various types of utensils, the name of a person, the name of an institution, and the name of a district such as a city; proper nouns; verbs that express an act, occurrence, or mode of being; adjectives; pronouns; and combinations thereof, i.e., compounds, phrases, and sentences.
